(19) United States
(12) Patent Application Publication
(10) Pub. No.: US 2022/0360852 A1
(43) Pub. Date: Nov. 10, 2022

(54) PLAYBACK MODE SWITCHING METHOD AND MULTIMEDIA DISPLAY APPARATUS THEREOF

(71) Applicant: BENQ CORPORATION, Taipei (TW)

(72) Inventor: Yu-Ching Tung, Taipei (TW)

(73) Assignee: BENQ CORPORATION, Taipei (TW)

(21) Appl. No.: 17/539,122

(22) Filed: Nov. 30, 2021

(30) Foreign Application Priority Data
May 10, 2021 (TW) 110116684

(51) Int. Cl. H04N 21/462; H04N 21/435; G06F 16/9535; G06F 16/435

(52) U.S. Cl. CPC H04N 21/462; H04N 21/435; G06F 16/9535; G06F 16/435

(57) ABSTRACT

A playback mode switching method includes a multimedia display apparatus displaying multimedia content, the multimedia display apparatus extracting related data from the multimedia content and uploading the related data to a web search engine, the web search engine transmitting a web search result back to the multimedia display apparatus according to the related data, the multimedia display apparatus analyzing the web search result to determine whether there is a sorting keyword in the web search result, and the multimedia display apparatus performing a playback mode switching operation for adjusting a playback parameter setting of the multimedia content when determining the sorting keyword exists.

### BACKGROUND OF THE INVENTION

### 1. Field of the Invention

The present invention relates to a playback mode switching method and a multimedia display apparatus thereof, and more specifically, to a playback mode switching method performing a web search on a multimedia content via a web search engine and accordingly performing a playback mode switching operation and a multimedia display apparatus thereof.

### 2. Description of the Prior Art

In general, a conventional multimedia display apparatus (e.g. a projector or a display monitor) usually has a playback parameter adjusting function for a user to adjust a multimedia content displayed by the multimedia display apparatus to meet his viewing needs, such as performing an OSD (On Screen Display) function of a display monitor by manually pressing a button set on the display monitor or by software. However, since there are so many playback parameters (e.g. brightness, contrast, definition, saturation, etc.) provided by the multimedia display apparatus for the user to adjust, it may cause a time-consuming and strenuous playback parameter adjusting process. Although the multimedia display apparatus can provide different playback modes (e.g. a theater mode and a game mode) built therein for the user to choose from, this design still requires the user to manually switch the multimedia display apparatus from one playback mode to anther playback mode. Thus, the aforesaid design is not convenient and quick enough in playback mode switching.

### SUMMARY OF THE INVENTION

The present invention provides a playback mode switching method. The playback mode switching method includes a multimedia display apparatus displaying multimedia content, the multimedia display apparatus extracting at least one related data from the multimedia content and uploading the at least one related data to a web search engine, the web search engine transmitting at least one web search result back to the multimedia display apparatus according to the at least one related data, the multimedia display apparatus analyzing the at least one web search result to determine whether there is at least one sorting keyword in the at least one web search result, and the multimedia display apparatus performing a playback mode switching operation for adjusting a playback parameter setting of the multimedia content when determining the sorting keyword exists.

The present invention further provides a multimedia display apparatus having a playback mode switching function. The multimedia display apparatus is coupled to a web search engine via network connection and includes a multimedia playback device, a multimedia processing device, and a network transmission device. The multimedia playback device displays a multimedia content. The multimedia processing device is electrically connected to the multimedia playback device for extracting at least one related data from the multimedia content. The network transmission device is electrically connected to the multimedia processing device, for transmitting at least one web search result generated by the web search engine according to the at least one related data back to the multimedia playback device, so as to make the multimedia processing device control the multimedia playback device to perform a playback mode switching operation for adjusting a playback parameter setting of the multimedia content when the multimedia processing device analyzes the at least one web search result to determine at least one sorting keyword exists.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a multimedia display apparatus according to an embodiment of the present invention.

FIG. 2 is a flowchart of a playback mode switching method according to an embodiment of the present invention.

### DETAILED DESCRIPTION

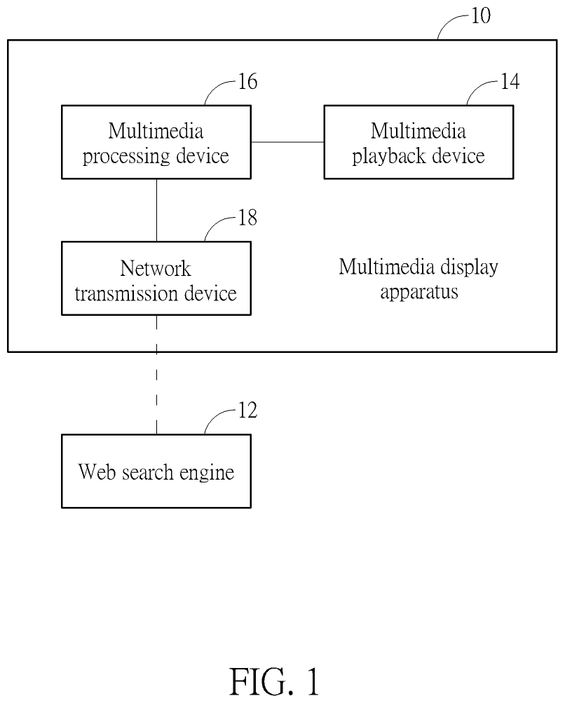

Please refer to FIG. 1, which is a functional block diagram of a multimedia display apparatus 10 according to an embodiment of the present invention. The multimedia display apparatus 10 could be a common multimedia device (e.g. a DLP (Digital Light Processing) projector or a smart LCD (Liquid Crystal Display) TV, but not limited thereto) having a multimedia playback function and a playback mode switching function (e.g. switching the multimedia display apparatus 10 to a game mode or a movie mode) and could be connected to a web search engine 12 (e.g. Google, Yahoo, Bing, or other fee-based web search engine) in a wireless or wired connection manner. As shown in FIG. 1, the multimedia display apparatus 10 includes a multimedia playback device 14, a multimedia processing device 16, and a network transmission device 18.

The multimedia playback device 14 (e.g. a projector lens device or an LCD panel) can display a multimedia content (e.g. a video game or a movie). The multimedia processing device 16 could be a microprocessor (e.g. a CPU (Central Processing Unit) or a GPU (Graphic Processing Unit)) for image processing in the multimedia display apparatus 10 and is electrically connected to the multimedia playback device 14. The multimedia processing device 16 can extract related data, such as a frame image (e.g. a game title image or a movie opening image) or content description information (e.g. a game genre or a movie name) , from the multimedia content displayed by the multimedia playback device 14. The network transmission device 18 could be a common network card (e.g. a wireless network card) for network transmission and is electrically connected to the multimedia processing device 16. The network transmission device 18 can transmit at least one web search result, which is generated by the web search engine 12 according to the related data, back to the multimedia processing device 16. In such a manner, when the multimedia processing device 16 analyzes the web search result to determine that a sorting keyword exists, the multimedia processing device 16 can control the multimedia playback device 14 to perform a playback mode switching operation for adjusting a playback parameter setting of the multimedia content. Accordingly, the multimedia display apparatus 10 can be automatically switched to a proper playback mode for meeting a user's current viewing needs, so as to improve the multimedia viewing experience of the user.

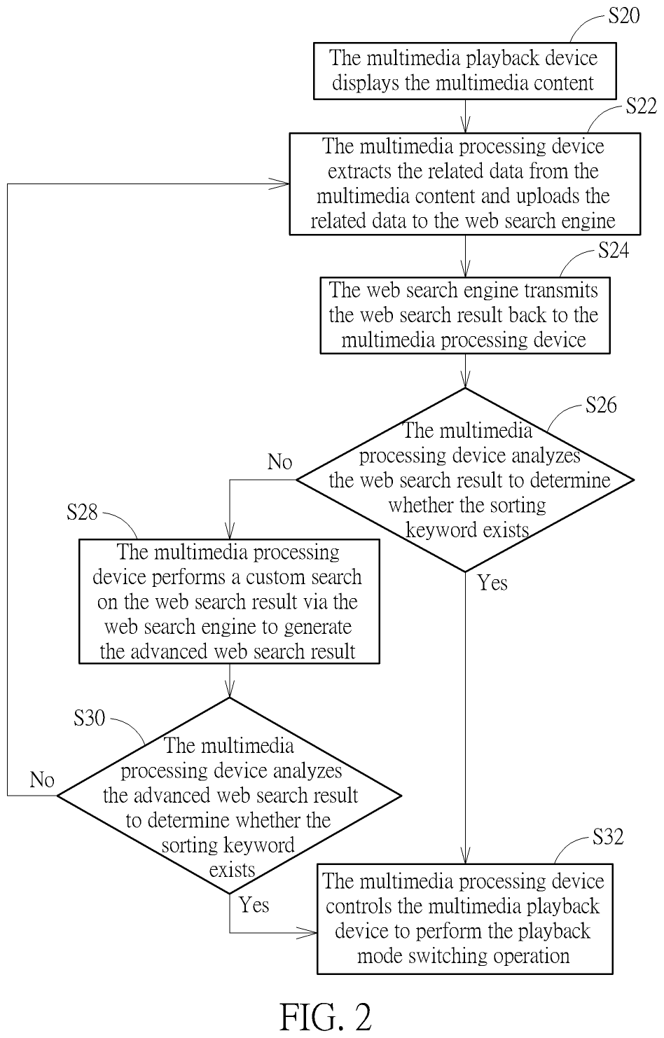

Please refer to FIG. 1 and FIG. 2. FIG. 2 is a flowchart of a playback mode switching method according to an embodiment of the present invention. The playback mode switching method of the present invention utilizing the multimedia display apparatus 10 to perform a playback mode switching operation includes the following steps.

Step S20: The multimedia playback device 14 displays the multimedia content.

Step S22: The multimedia processing device 16 extracts the related data from the multimedia content and uploads the related data to the web search engine 12.

Step S24: The web search engine 12 transmits at least one web search result back to the multimedia processing device 16 according to the related data.

Step S26: The multimedia processing device 16 analyzes the web search result to determine whether the sorting keyword exists in the web search result; if so, go to Step S32; if not, go to Step S28.

Step S28: The multimedia processing device 16 performs a custom search on the web search result via the web search engine 12 to generate at least one advanced web search result.

Step S30: The multimedia processing device 16 analyzes the advanced web search result to determine whether the sorting keyword exists in the advanced web search result; if so, go to Step S32; if not, go to Step S22.

Step S32: The multimedia processing device 16 controls the multimedia playback device 14 to perform the playback mode switching operation when determining the sorting keyword exists.

More detailed description for the aforesaid steps is provided as follows. In Step S20, the user can operate the multimedia playback device 14 to display the multimedia content desired to view, such as projecting game images via a projector or displaying a movie via an LCD TV. At this time, the multimedia processing device 16 can extract the related data from the multimedia content and upload the related data to the web search engine 12 (Step S22). To be more specific, the related data could include at least one frame image (e.g. a first frame image, but not limited thereto, meaning that the present invention could also adopt other frame image or multiple frame images in a certain period of time) , and the network transmission device 18 can upload the extracted frame image to the web search engine 12 for image identification to generate at least one web search result (Step S24). For example, the network transmission device 18 can upload an extracted game title image to Google image search engine, and Google image search engine can perform image identification on the uploaded game title image and then transmit at least one web search result, which could be listed from the most relevant to the least relevant, back to the multimedia processing device 16 via the network transmission device 18.

After receiving the web search result transmitted from the web search engine 12, the multimedia processing device 16 can analyze the web search result to determine whether the sorting keyword exists in the web search result (Step S26). To be more specific, in this embodiment, the multimedia processing device 16 could adopt a parsing method to compare web page information (e.g. JSON format data) in the web search result transmitted from Google image search engine, so as to determine whether the sorting keyword (e.g. game or sport) exists. As for the related description for the aforesaid parsing method, it is common seen in the prior art and omitted herein.

During the aforesaid process, when the multimedia processing device 16 determines that the sorting keyword exists, the multimedia processing device 16 can correspondingly control the multimedia device 14 to perform the playback mode switching operation (Step S32). For example, if the sorting keyword (e.g. game) exists in the web search result, the multimedia processing device 16 can switch the multimedia playback device 14 to a corresponding image playback mode (e.g. a game mode) , so as to control the multimedia playback device 14 to adjust the playback parameter setting of the multimedia content (e.g. increasing the image brightness and contrast of the multimedia content, but not limited thereto). In such a manner, the multimedia display apparatus 10 can be automatically switched to a proper image playback mode for meeting the user's current viewing needs without any manual operation, so as to efficiently improve the multimedia viewing experience of the user. Furthermore, after Step S32 is performed, the multimedia display apparatus 10 can be operable to adjust at least one playback parameter (e.g. brightness, contrast, definition, saturation, etc.) in the playback parameter setting, so as to allow the user to perform a fine adjustment on the playback parameter setting after the playback mode switching operation is performed. As such, the playback effect provided by the multimedia content can be more suitable for the user's preference, so as to optimize the multimedia viewing experience of the user.

To be noted, the multimedia processing device 16 can further perform the custom search on the aforesaid web search result via the web search engine 12 to generate at least one advanced web search result and obtain an advanced sorting keyword, so as to achieve the purpose that the multimedia playback device 14 can be switched to a proper image playback mode more suitable for the user's viewing needs. For example, if the first web search result is a game title web page, such as “Sonic at the Olympic Games-Tokyo 2020”, the multimedia processing device 16 can upload “Sonic at the Olympic Games-Tokyo 2020” to the web search engine 12 for the custom search according to Google custom search syntax, and the web search engine 12 can correspondingly transmit at least one advanced web search result, which could be listed from the most relevant to the least relevant, back to the multimedia processing device 16 via the network transmission device 18.

Subsequently, the multimedia processing device 16 can adopt the aforesaid parsing method to compare web page information (e.g. JSON format data) in the advanced web search result, for determining whether the advanced sorting keyword (e.g. SPG (Sport Game) or FPG (First Personal Game)) exists.

In such a manner, when the multimedia processing device 16 determines that the advanced sorting keyword exists in the advanced web search result, the multimedia processing device 16 can control the multimedia playback device 14 to perform the playback mode switching operation. For example, if the multimedia processing device 16 analyzes the advanced sorting keyword as SPG, the multimedia processing device 16 can switch the multimedia playback device 14 from a game mode to a sport game mode, so as to control the multimedia playback device 14 to perform an advanced adjustment (e.g. increasing the refresh rate of the multimedia playback device 14 or the image sharpness of the multimedia content) on the playback parameter setting of the multimedia content for further optimizing the multimedia viewing experience of the user.

On the other hand, if the multimedia processing device 16 determines that no sorting keyword exists in the web search result, the multimedia processing device 16 can perform the custom search on the web search result via the web search engine 12 to generate at least one advanced web search result (Step S28). For example, the multimedia processing device 16 could upload the web page name of the first web search result to the web search engine 12 for the custom search, and the web search engine 12 could correspondingly transmit at least one advanced web search result, which could be listed from the most relevant to the least relevant, back to the multimedia processing device 16 via the network transmission device 18.

Subsequently, the multimedia processing device 16 could analyze the advanced web search result to determine whether the sorting keyword exists in the advanced web search result (Step S30). In this step, the multimedia processing device 16 could also adopt the aforesaid parsing method to compare web page information (e.g. JSON format data) in the advanced web search result, for determining whether the sorting keyword (e.g. live, sport, video, etc.) exists.

During the aforesaid process, if the multimedia processing device 16 determines that the sorting keyword exists in the advanced web search result, the multimedia processing device 16 can correspondingly control the multimedia playback device 14 to perform the playback mode switching operation (Step S32). For example, if a video-related keyword (e.g. video) exists in the advanced web search result, the multimedia processing device 16 can switch the multimedia playback device 14 to a movie mode for controlling the multimedia playback device 14 to adjust the playback parameter setting of the multimedia content (e.g. increasing the image saturation and contrast of the multimedia content). As such, the multimedia display apparatus 10 can be automatically switched to a preferable image playback mode suitable for the user's current viewing needs without any manual operation, so as to efficiently improve the multimedia viewing experience of the user.

On the contrary, if the multimedia processing device 16 determines that no sorting keyword exists in the advanced web search result, the multimedia processing device 16 can extract other related data (e.g. extracting multiple frame images in another period of time) from the multimedia content and upload this related data to the web search engine 12 (Step S22) for performing the aforesaid steps again until the sorting keyword is determined for switching the multimedia display apparatus 10 to a proper image playback mode suitable for the user's viewing needs.

Compared with the prior art, the present invention utilizes the web search engine to obtain the web search result according to the related data of the multimedia content, and then performs the playback mode switching operation of the multimedia display apparatus according to the sorting keyword obtained by analyzing the web search result. As such, the multimedia display apparatus can be automatically switched to a preferable playback mode suitable for the user' s current viewing needs without any manual operation. That is, the present invention can efficiently solve the prior art problem that the playback parameter adjusting process is time-consuming and strenuous, so as to greatly improve operational convenience of the multimedia display apparatus and optimize the multimedia viewing experience of the user.

It should be mentioned that the present invention is not limited to the aforesaid image search method, which means the present invention could adopt a text search method. In brief, in another embodiment, if the related data includes at least one content description information (e.g. a game genre or a movie name) of the multimedia content, the multimedia processing device 16 can upload the content description information to Google search engine, and then Google search engine can perform a keyword search on the content description information and transmit at least one web search result back to the multimedia processing device 16 via the network transmission device 18 for subsequent playback mode switching. As for the other related description for this embodiment, it could be reasoned by analogy according to the aforesaid embodiments and omitted herein.

Furthermore, the playback mode switching method of the present invention could be applied to automatic audio playback mode switching (e.g. switching the multimedia playback device 14 to a theater mode or a music mode). For example, if a movie-related keyword (e.g. video) exists in the aforesaid web search result, the multimedia processing device 16 can switch the multimedia playback device 14 to a theater mode for controlling the multimedia playback device 14 to adjust audio parameters of the multimedia content (e.g. enhancing the bass effect of the multimedia playback device 14). As for the other related description for this embodiment, it could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A playback mode switching method comprising:
a multimedia display apparatus displaying multimedia content;
the multimedia display apparatus extracting at least one related data from the multimedia content and uploading the at least one related data to a web search engine;
the web search engine transmitting at least one web search result back to the multimedia display apparatus according to the at least one related data;
the multimedia display apparatus analyzing the at least one web search result to determine whether there is at least one sorting keyword in the at least one web search result; and
the multimedia display apparatus performing a playback mode switching operation for adjusting a playback parameter setting of the multimedia content when determining the sorting keyword exists.

2. The playback mode switching method of claim 1, wherein the at least one related data comprises at least one frame image in the multimedia content, and the multimedia display apparatus uploads the at least one frame image to the web search engine for image identification to generate the at least one web search result.

3. The playback mode switching method of claim 2, wherein the playback parameter setting comprises at least one image playback parameter, and the playback mode switching operation comprises switching the multimedia display apparatus to an image playback mode for adjusting the at least one image playback parameter of the multimedia content.

4. The playback mode switching method of claim 2, wherein the playback parameter setting comprises at least one audio playback parameter, and the playback mode switching operation comprises switching the multimedia display apparatus to an audio playback mode for adjusting the at least one audio playback parameter of the multimedia content.

5. The playback mode switching method of claim 1, wherein the at least one related data comprises at least one content description information in the multimedia content, and the multimedia display apparatus uploads the at least one content description information to the web search engine for a keyword search to generate the at least one web search result.

6. The playback mode switching method of claim 5, wherein the playback parameter setting comprises at least one image playback parameter, and the playback mode switching operation comprises switching the multimedia display apparatus to an image playback mode for adjusting the at least one image playback parameter of the multimedia content.

7. The playback mode switching method of claim 5, wherein the playback parameter setting comprises at least one audio playback parameter, and the playback mode switching operation comprises switching the multimedia display apparatus to an audio playback mode for adjusting the at least one audio playback parameter of the multimedia content.

8. The playback mode switching method of claim 1, wherein the step of the multimedia display apparatus performing the playback mode switching operation for adjusting the playback parameter setting of the multimedia content when determining the sorting keyword exists comprises:
the multimedia display apparatus performing a custom search on the at least one web search result via the web search engine to generate at least one advanced web search result;
the multimedia display apparatus analyzing the at least one advanced web search result to obtain at least advanced sorting keyword; and
the multimedia display apparatus performing the playback mode switching operation according to the at least one sorting keyword and the at least one advanced sorting keyword.

9. The playback mode switching method of claim 1 further comprising:
the multimedia display apparatus performing a custom search on the at least one web search result via the web search engine to generate at least one advanced web search result when determining no sorting keyword exists in the at least web search result; and
the multimedia display apparatus analyzing the at least one advanced web search result to determine whether there is the at least one sorting keyword in the at least one advanced web search result.

10. The playback mode switching method of claim 1 further comprising:
the multimedia display apparatus being operable to adjust at least one playback parameter in the playback parameter setting after the multimedia display apparatus performs the playback mode switching operation for adjusting the playback parameter setting.

11. A multimedia display apparatus having a playback mode switching function, the multimedia display apparatus being coupled to a web search engine via network connection and comprising:
a multimedia playback device displaying a multimedia content;
a multimedia processing device electrically connected to the multimedia playback device for extracting at least one related data from the multimedia content; and
a network transmission device electrically connected to the multimedia processing device, for transmitting at least one web search result generated by the web search engine according to the at least one related data back to the multimedia playback device, so as to make the multimedia processing device control the multimedia playback device to perform a playback mode switching operation for adjusting a playback parameter setting of the multimedia content when the multimedia processing device analyzes the at least one web search result to determine at least one sorting keyword exists.

12. The multimedia display apparatus of claim 11, wherein the at least one related data comprises at least one frame image in the multimedia content, and the network transmission device uploads the at least one frame image to the web search engine for image identification to generate the at least one web search result.

13. The multimedia display apparatus of claim 12, wherein the playback parameter setting comprises at least one image playback parameter, and the playback mode switching operation comprises the multimedia processing device switching the multimedia playback device to an image playback mode for adjusting the at least one image playback parameter of the multimedia content.

14. The multimedia display apparatus of claim 12, wherein the playback parameter setting comprises at least one audio playback parameter, and the playback mode switching operation comprises the multimedia processing device switching the multimedia playback device to an audio playback mode for adjusting the at least one audio playback parameter of the multimedia content.

15. The multimedia display apparatus of claim 11, wherein the at least one related data comprises at least one content description information in the multimedia content, and the network transmission device uploads the at least one content description information to the web search engine for a keyword search to generate the at least one web search result.

16. The multimedia display apparatus of claim 15, wherein the playback parameter setting comprises at least one image playback parameter, and the playback mode switching operation comprises the multimedia processing device switching the multimedia playback device to an image playback mode for adjusting the at least one image playback parameter of the multimedia content.

17. The multimedia display apparatus of claim 15, wherein the playback parameter setting comprises at least one audio playback parameter, and the playback mode switching operation comprises the multimedia processing device switching the multimedia playback device to an audio playback mode for adjusting the at least one audio playback parameter of the multimedia content.

18. The multimedia display apparatus of claim 11, wherein the multimedia processing device performs a custom search on the at least one web search result via the web search engine to generate at least one advanced web search result, the multimedia processing device analyzes the at least one advanced web search result to obtain at least advanced sorting keyword, and the multimedia processing device performs the playback mode switching operation according to the at least one sorting keyword and the at least one advanced sorting keyword.

19. The multimedia display apparatus of claim 11, wherein the multimedia processing device performs a custom search on the at least one web search result via the web search engine to generate at least one advanced web search result when determining no sorting keyword exists in the at least web search result, and the multimedia processing device analyzes the at least one advanced web search result to determine whether there is the at least one sorting keyword in the at least one advanced web search result.

20. The multimedia display apparatus of claim 11, wherein the multimedia playback device is operable to adjust at least one playback parameter in the playback parameter setting after the playback mode switching operation is performed for adjusting the playback parameter setting.
